(19) United States
(12) Patent Application Publication
(10) Pub. No.: US 2021/0294134 A1
(43) Pub. Date: Sep. 23, 2021

(54) BACKLIGHT MODULE AND METHOD OF REGULATING TRANSMITTANCE THEREOF

(71) Applicant: TCL CHINA STAR OPTOELECTRONICS TECHNOLOGY CO., LTD., Shenzhen (CN)

(72) Inventor: Baolin CHI, Shenzhen (CN)

(73) Assignee: TCL CHINA STAR OPTOELECTRONICS TECHNOLOGY CO., LTD., Shenzhen (CN)

(21) Appl. No.: 16/620,531

(22) PCT Filed: Sep. 23, 2019
(86) PCT No.: PCT/CN2019/107185

§ 371 Date: Dec. 9, 2019

(30) Foreign Application Priority Data
Jul. 10, 2019 (CN) 201910619864.4

(51) Int. Cl. G02F 1/1334; G02F 1/13357

(52) U.S. Cl. CPC G02F 1/1334; G02F 1/133603

(57) ABSTRACT

The present invention provides a backlight module and a method of regulating transmittance thereof, and a display, wherein the backlight module includes: a substrate; a backlight disposed on the substrate; and a polymer dispersed liquid crystal layer disposed above the backlight, wherein the polymer dispersed liquid crystal layer has at least two different polymerization directions to reduce a difference between an amount of light emitted from an oblique viewing angle and an amount of light emitted from a vertical viewing angle.

### BACKGROUND OF INVENTION

### Field of Invention

The present invention relates to a field of displays, and in particular to a backlight module and a method of regulating transmittance thereof and a display.

### Description of Prior Art

With development of a liquid crystal display (LCD) panel industry, its size is constantly increasing, and requirements for technology and specification are constantly upgrading. The market demand of TV display panel size has been changed from 32-inch and 55-inch to 43-inch and 65-inch, and specifications are constantly upgrading. Terminal requirements for products are also constantly improving. Most existing displays have a color shift phenomenon, which occurs mainly because different light outputs from different viewing angles when a backlight passes through the LCD.

In the past, in order to improve the color shift problem, a polarizer (POL) is employed with the LCD to ensure that transmission lights of the POL and the LCD have the same amount of optical delay, and to reduce the optical delay of the LCD, thus reducing a difference in light propagation, thereby ensuring consistent amounts of the light emitted from different viewing angles. However, for the color shift problem, the existing panel technology is challenged because the requirements of different manufacturers for specifications are more diverse and more stringent.

Accordingly, in order to avoid occurrence of color shift more perfectly, there is an urgent need for a backlight module, a method of regulating transmittance thereof, and a display, to achieve uniform light transmission at different viewing angles.

### SUMMARY OF INVENTION

In view of this, the present invention provides a novel backlight module, a method of regulating transmittance thereof, and a display, wherein a polymer dispersed liquid crystal layer (PLCD) is introduced between a liquid crystal display (LCD) and a backlight (BL) to correct a difference in brightness and chromaticity between the oblique and vertical viewing angles. A polymerization direction of polymers of the PDLC is regulated according to different viewing angles to adjust the direction of correction, thus improving a viewing taste at the oblique viewing angle.

According to an embodiment of the present invention, a backlight module is provided, which includes: a substrate; a backlight disposed on the substrate; and a polymer dispersed liquid crystal layer disposed above the backlight, wherein the polymer dispersed liquid crystal layer has at least two different polymerization directions to reduce a difference between an amount of light emitted from an oblique viewing angle and an amount of light emitted from a vertical viewing angle.

According to another embodiment of the present invention, the present invention further provides a display including a backlight module, wherein the backlight module includes: a substrate; a backlight disposed on the substrate; and a polymer dispersed liquid crystal layer disposed above the backlight, wherein the polymer dispersed liquid crystal layer has at least two different polymerization directions to reduce a difference between an amount of light emitted from an oblique viewing angle and an amount of light emitted from a vertical viewing angle.

According to an embodiment of the invention, a method of regulating transmittance of a backlight module is further provided, which includes the following steps:

S10, providing a polymer dispersed liquid crystal layer;

S20, performing a first UV irradiation on the polymer dispersed liquid crystal layer to polymerize a part of polymers in the polymer dispersed liquid crystal layer in a first direction;

S30, performing a second UV irradiation on the polymer dispersed liquid crystal layer, so that another part of the polymer in the polymer dispersed liquid crystal layer is polymerized in a second direction, such that the polymer dispersed liquid crystal layer has at least two different polymerization directions to reduce a difference between an amount of light emitted from an oblique viewing angle and an amount of light emitted from a vertical viewing angle; and

S40, preparing a backlight module, wherein the backlight module includes: a substrate; a backlight disposed on the substrate; and the polymer dispersed liquid crystal layer is disposed above the backlight.

According to an embodiment of the invention, a display is also provided, which includes the above backlight module.

According to an embodiment of the invention, the display further includes a liquid crystal layer disposed above the backlight module, wherein the polymer dispersed liquid crystal layer is disposed between the backlight and the liquid crystal layer

According to an embodiment of the invention, the polymer dispersed liquid crystal layer has a multilayered structure or a single-layered structure.

According to an embodiment of the invention, the backlight module further includes an optical function layer disposed above the polymer dispersed liquid crystal layer, wherein the optical function layer has a multilayered structure or a single-layered structure, and includes a brightness enhancing film.

According to an embodiment of the invention, the backlight module further includes an optical function layer disposed above the polymer dispersed liquid crystal layer, wherein the optical function layer has a multilayered structure or a single-layered structure, and includes a brightness enhancing film.

The invention provides a novel backlight module, a method of regulating transmittance thereof, and a display, wherein a polymer dispersed liquid crystal layer (PLCD) is introduced between a liquid crystal display (LCD) and a backlight (BL) to correct a difference in brightness and chromaticity between the oblique and vertical viewing angles. A polymerization direction of polymers of the PDLC is regulated according to different viewing angles to adjust the direction of correction, thus improving a viewing taste at the oblique viewing angle.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic diagram of a backlight module according to an embodiment of the invention.

FIG. 2 is a flow chart of a method of regulating transmittance of a backlight module according to an embodiment of the invention.

FIG. 3 is a schematic diagram of a display according to an embodiment of the present invention.

### DETAILED DESCRIPTION OF PREFERRED EMBODIMENTS

In order to make the above description of the present invention more comprehensible, the preferred embodiments are described below in detail with reference to the accompanying drawings.

The following description of the various embodiments is provided to illustrate the specific embodiments of the invention. Directional terms mentioned in the present invention, such as “vertical”, “horizontal”, “upper”, “bottom”, “pre”, “post”, “left”, “right”, “inside”, “outside”, “side”, etc., only refer to the direction of the additional drawing. Therefore, the directional terminology used is for the purpose of illustration and understanding of the invention. In the figures, structurally similar elements are denoted by the same reference numerals.

In order to solve the problems of the prior art, the present invention provides a novel backlight module, a method of regulating transmittance thereof, and a display, wherein a polymer dispersed liquid crystal layer (PLCD) is introduced between a liquid crystal display (LCD) and a backlight (BL) to correct a difference in brightness and chromaticity between the oblique and vertical viewing angles. A polymerization direction of polymers of the PDLC is regulated according to different viewing angles to adjust the direction of correction, thus improving a viewing taste at the oblique viewing angle.

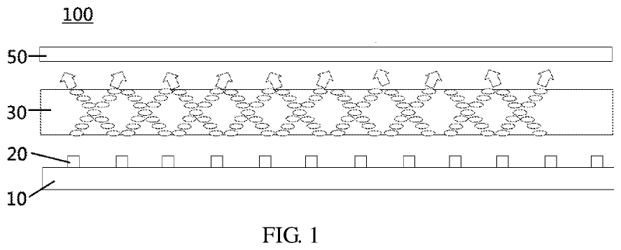

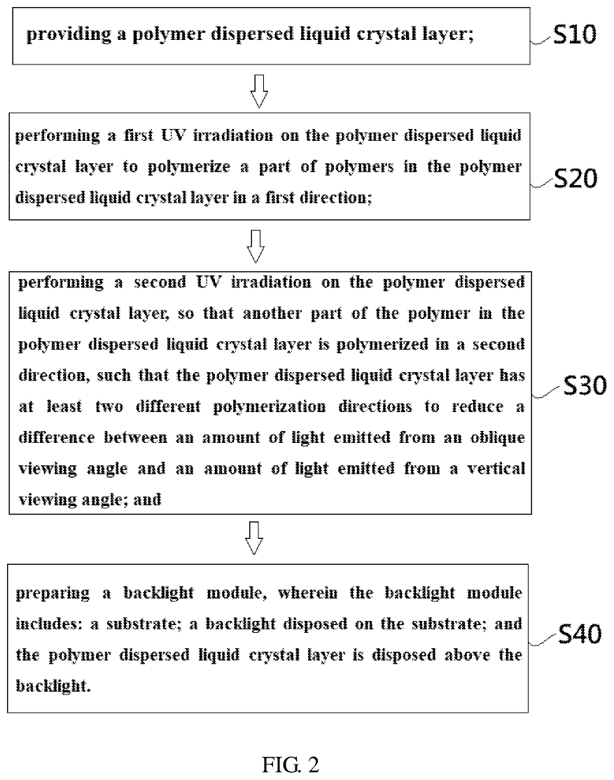

FIG. 1 is a schematic diagram of a backlight module according to an embodiment of the invention. FIG. 2 is a flow chart of a method of regulating transmittance of a backlight module according to an embodiment of the invention. Referring to FIG. 1 and FIG. 2, specifically, the present invention provides a backlight module 100 including: a substrate 10; a backlight 20 disposed on the substrate 10; and a polymer dispersed liquid crystal layer 30 disposed on the backlight 20, wherein the polymer dispersed liquid crystal layer 30 has at least two different polymerization directions to reduce a difference between an amount of light emitted from an oblique viewing angle and an amount of light emitted from a vertical viewing angle.

The polymer-dispersed liquid crystal layer 30 does not influence the light emitted from a vertical viewing angle, and makes the light emitted from an oblique viewing angle more uniform (indicated by the arrow in FIG. 1) and consistent with the light emitted from a vertical viewing angle. If a specific viewing angle is required, an arrangement direction of polymers of the polymer dispersed liquid crystal layer 30 can be adjusted to regulate a direction of liquid crystals of the polymer dispersed liquid crystal layer 30, and thus regulate a brightness of the backlight 20, to achieve the effect of improving the transmittance at the specific viewing angle.

Still referring to FIG. 1 and FIG. 2, in accordance with an embodiment of the present invention, the present invention further provides a method of regulating transmittance of a backlight module 100, including the following steps:

S10, providing a polymer dispersed liquid crystal layer 30;

S20, performing first UV irradiation on the polymer dispersed liquid crystal layer 30 to polymerize a part of polymers in the polymer dispersed liquid crystal layer 30 in a first direction;

S30, performing a second UV irradiation on the polymer dispersed liquid crystal layer 30, so that another part of the polymers in the polymer dispersed liquid crystal layer 30 is polymerized in a second direction, such that the polymer dispersed liquid crystal layer 30 has at least two different polymerization directions to reduce a difference between an amount of light emitted from an oblique viewing angle and an amount of light emitted from a vertical viewing angle; and

S40, preparing a backlight module 100, wherein the backlight module 100 includes: a substrate 10; a backlight 20 disposed on the substrate 10; and the polymer dispersed liquid crystal layer 30 disposed above the backlight 20.

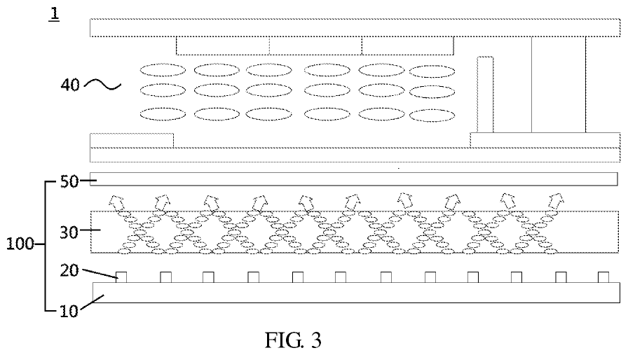

FIG. 3 is a schematic diagram of a display in accordance with an embodiment of the present invention. Referring to FIG. 3, specifically, the present invention further provides a display 1 including the above backlight module 100.

As shown in FIG. 3, the display 1 further includes a liquid crystal layer 40 disposed above the backlight module 100, wherein the polymer dispersed liquid crystal layer 30 is disposed between the backlight 20 and the liquid crystal layer 40.

According to an embodiment of the invention, the polymer dispersed liquid crystal layer 30 is a multilayered structure or a single-layered structure.

According to an embodiment of the invention, the backlight module 100 further includes an optical function layer 50 disposed above the polymer dispersed liquid crystal layer 30, wherein the optical function layer 50 is a multilayered structure or a single-layered structure, including a brightness enhancing film (not shown).

According to an embodiment of the invention, the backlight 20 includes a single light source, a plurality of light emitting diodes, or a plurality of mini-light emitting diodes, as shown in FIG. 2.

Accordingly, the present invention provides a novel backlight module, a method of regulating transmittance thereof, and a display, wherein a polymer dispersed liquid crystal layer (PLCD) is introduced between a liquid crystal display (LCD) and a backlight (BL) to correct a difference in brightness and chromaticity between the oblique and vertical viewing angles. A polymerization direction of polymers of the PDLC is controlled according to different viewing angles to adjust the direction of correction, thus improving a viewing taste at the oblique viewing angle.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A backlight module, comprising:
a substrate;
a backlight disposed on the substrate; and
a polymer dispersed liquid crystal layer disposed above the backlight, wherein the polymer dispersed liquid crystal layer has at least two different polymerization directions to reduce a difference between an amount of light emitted from an oblique viewing angle and an amount of light emitted from a vertical viewing angle.

2. The backlight module according to claim 1, wherein the polymer dispersed liquid crystal layer has a multilayered structure or a single-layered structure.

3. The backlight module according to claim 1, further comprising an optical function layer disposed above the polymer dispersed liquid crystal layer, wherein the optical function layer has a multilayered structure or a single-layered structure, and comprises a brightness enhancing film.

4. The backlight module according to claim 3, wherein the backlight comprises a single light source, a plurality of light emitting diodes, or a plurality of mini light emitting diodes.

5. A display comprising a backlight module, wherein the backlight module comprises:
a substrate
a backlight disposed on the substrate; and
a polymer dispersed liquid crystal layer disposed above the backlight, wherein the polymer dispersed liquid crystal layer has at least two different polymerization directions to reduce a difference between an amount of light emitted from an oblique viewing angle and an amount of light emitted from a vertical viewing angle.

6. The display according to claim 5, wherein the polymer dispersed liquid crystal layer has a multilayered structure or a single-layered structure.

7. The display according to claim 5, wherein the backlight module further comprises an optical function layer disposed above the polymer dispersed liquid crystal layer, wherein the optical function layer has a multilayered structure or a single-layered structure, and comprises a brightness enhancing film.

8. The display according to claim 7, wherein the backlight comprises a single light source, a plurality of light emitting diodes, or a plurality of mini-light emitting diodes.

9. The display according to claim 5, further comprising a liquid crystal layer disposed above the backlight module, wherein the polymer dispersed liquid crystal layer is disposed between the backlight and the liquid crystal layer.

10. A method of regulating transmittance of a backlight module, comprising the following steps:
S10, providing a polymer dispersed liquid crystal layer;
S20, performing a first UV irradiation on the polymer dispersed liquid crystal layer to polymerize a part of polymers in the polymer dispersed liquid crystal layer in a first direction;
S30, performing a second UV irradiation on the polymer dispersed liquid crystal layer, so that another part of the polymer in the polymer dispersed liquid crystal layer is polymerized in a second direction, such that the polymer dispersed liquid crystal layer has at least two different polymerization directions to reduce a difference between an amount of light emitted from an oblique viewing angle and an amount of light emitted from a vertical viewing angle; and
S40, preparing a backlight module, wherein the backlight module comprises:
a substrate
a backlight disposed on the substrate; and
the polymer dispersed liquid crystal layer disposed above the backlight.

11. The method according to claim 10, wherein the polymer dispersed liquid crystal layer has a multilayered structure or a single-layered structure.

12. The method according to claim 10, wherein the backlight module further comprises an optical function layer disposed above the polymer dispersed liquid crystal layer, wherein the optical function layer has a multilayered structure or a single-layered structure, and comprises a brightness enhancing film.

13. The method according to claim 10, wherein the backlight comprises a single light source, a plurality of light emitting diodes, or a plurality of mini light emitting diodes.
